(19) United States
(12) Patent Application Publication
(10) Pub. No.: US 2008/0225154 A1
(43) Pub. Date: Sep. 18, 2008

(54) DIGITAL CAMERA AND MENU DISPLAY METHOD OF SAME

(75) Inventors: PENG-YU PAN, Tu-Cheng (TW); KANG-SHUN HSU, Tu-Cheng (TW); SHUN-LING KAO, Tu-Cheng (TW); HSIANG-EN PENG, Tu-Cheng (TW); YU-TSUNG SU, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/868,344

(22) Filed: Oct. 5, 2007

(30) Foreign Application Priority Data
Mar. 16, 2007 (CN) 200710200295.7

(51) Int. Cl. H04N 5/222

(52) U.S. Cl. 348/333.02; 348/E05.022

(57) ABSTRACT

A digital camera includes a rotatable wheel, a screen, and a menu display system for displaying menu on the screen. The menu display system includes a primary menu having a number of menu options and may have one or more hierarchical submenu options. The submenu is disk-shaped with a number of sub-submenu options displayed around the disk, each of the sub-submenu options can be selected by rotating the rotatable wheel clockwise or anticlockwise. The digital camera is capable of being operated quickly and efficiently.

### BACKGROUND

1. Technical Field

The present invention relates to digital cameras, particularly, to a digital camera with a menu display system capable of being operated quickly and efficiently and the menu display method of the digital camera.

2. Description of Related Art

As is well known, graphical user interfaces (GUIs) are used in many interactive applications in which it is necessary for a user to occasionally select one of a hierarchical series of user selectable options. Such GUIs can be found in many electronic devices, such as computer systems, televisions, automatic teller machines, games consoles, digital cameras and the like.

For interactive applications that may require multiple menu structures, the GUI should be simple and flexible if the user is to be able to use such an application efficiently. This may be achieved to some extent by providing a menu display which is suitable for interfacing with a simple, ergonomic input device and having a menu display which is intuitive in its operation. The GUI is offered by a menu display system used in the electronic device.

What is needed, therefore, is a menu display system, for a device such as a digital camera, that offers a GUI that is simple and efficient.

### SUMMARY

In accordance with one embodiment, a digital camera includes a rotatable wheel, a screen, and a menu display system for displaying at least one menu on the screen. The menu display system includes a primary menu having a number of primary menu options and at least one submenu corresponding to the primary menu options. The submenu is disk-shaped with a number of submenu options displayed around the disk, each of the submenu options is selectable by rotating the rotatable wheel clockwise or anticlockwise.

In accordance with one embodiment, a menu display method of a digital camera, the digital camera comprising a rotatable wheel, and a screen, includes the steps of: displaying a primary menu with a number of primary menu options on the screen; rotating the rotatable wheel to select a primary menu option; and opening the selected primary menu option and displaying a submenu corresponding to the selected primary menu option, the submenu being disk-shaped and having a number of submenu options selectable by rotating the rotatable wheel displayed around the disk.

### BRIEF DESCRIPTION OF THE DRAWING

Many aspects of the present digital camera can be better understood with reference to the following drawings. The components in the drawing are not necessarily drawn to scale, the emphasis instead being placed upon clearly illustrating the principles of the present digital camera. Moreover, in the drawing, like reference numerals designate corresponding parts throughout the several views.

FIG. 1 shows is a schematic view of a digital camera according to a preferred embodiment;

FIG. 2A to FIG. 2D shows a menu display system of the digital camera of FIG. 1; and

FIG. 3 is a flow chart of a menu display method of the digital camera of FIG. 1.

### DETAILED DESCRIPTION OF THE EMBODIMENTS

Embodiments will now be described, in detail, below with reference to the drawings.

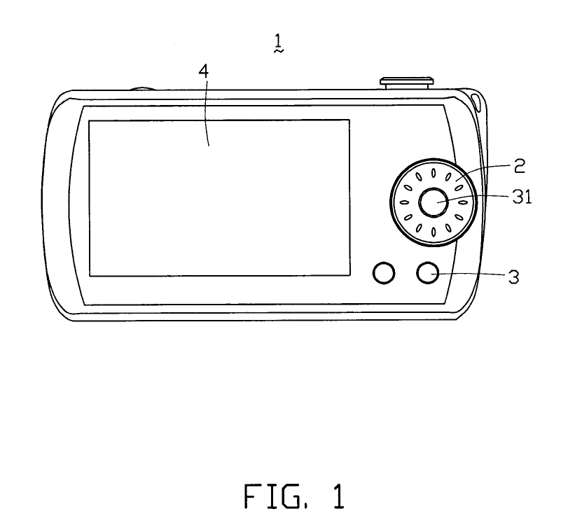

Referring to FIG. 1, a digital camera 1 according to a preferred embodiment is shown. The digital camera 1 includes a rotatable wheel 2, a number of buttons 3, a screen 4, and a menu display system (not shown) for displaying menu on the screen 4.

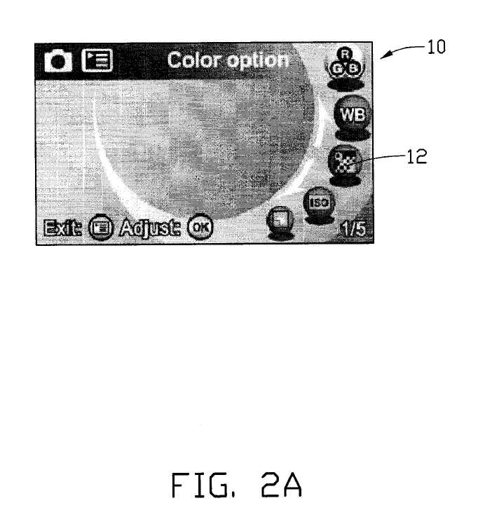

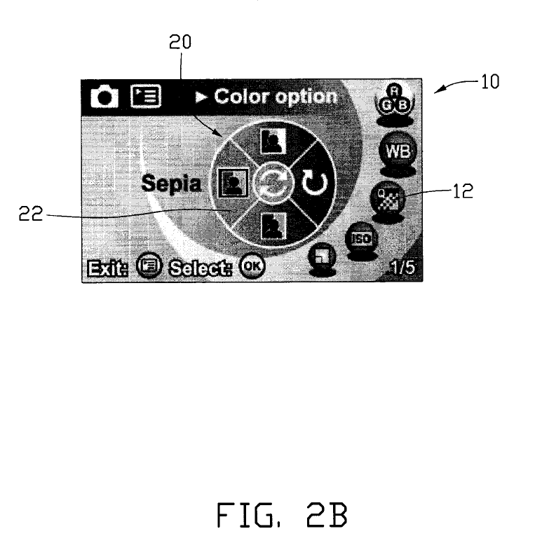

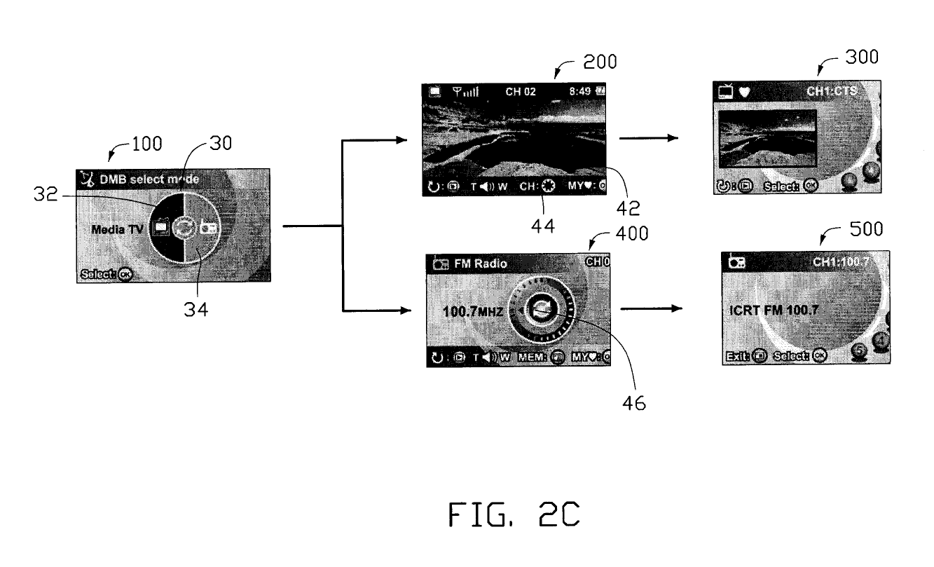

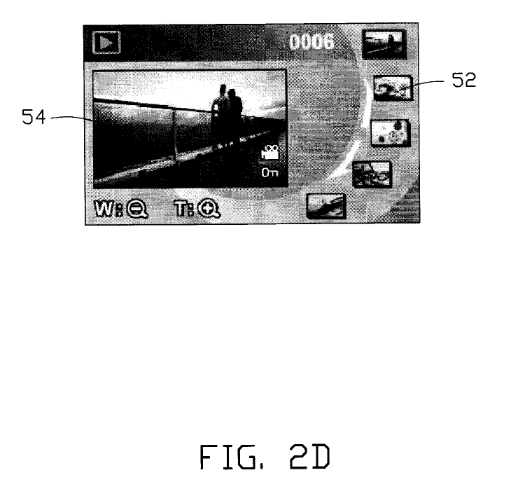

Referring to FIG. 2A, after the digital camera 1 is turned on the menu display system is shown including a primary menu 10. The primary menu 10 includes a number of primary menu options 12. The primary menu options 12 are arranged in a curved fashion or a circle on the screen 4. Users can select any primary menu option 12 by rotating the rotatable wheel 2 clockwise or anticlockwise. A selected primary menu option 12 would be indicated differently from the others. For example, the selected primary menu option 12 would be brighter or darker than the other non-selectable options. In the present embodiment, the number of buttons 3 includes an activation button 31, the activation button 31 is configured for opening the selected primary menu option 12, for example, by pressing it. Preferably, the activation button 31 is disposed in the center of the rotatable wheel 2.

Further referring to FIG. 2B, the menu display system further includes a number of submenu 20. By opening a primary menu option 12, a submenu 20 can be shown on the screen 4. The submenu 20 is disk-shaped. The submenu 20 includes a number of submenu options 22 displayed around the disk. Preferably, the disk can be divided into many identically sized areas according to the number of the submenu options 22. Every submenu option 22 can be selected by rotating the rotatable wheel 2 clockwise or anticlockwise. A selected submenu option 22 can be indicated differently from the others. For example, the selected submenu option 22 would be indicated by brightening or darkening. In present embodiment, a selected submenu option 22 can be opened by pressing the activation button 31, then an application corresponding to the selected submenu option 22 would be carried out or a sub-submenu of the selected submenu option 22 would be shown on the screen 4. Preferably, the sub-submenu of the selected submenu option 22 is disk-shaped, and sub-submenu options are displayed around the disk. It can be understood that, if a primary menu option 12 has no submenu 20 and only corresponds to an application, the application would be opened when the primary menu option 12 is opened.

As shown in FIG. 2C, in a digital media mode of the digital camera 1, a view 100 will be displayed on the screen 4. A submenu 30 is shown in the view 100, the submenu 30 has two submenu options 32,34 corresponding to a TV option and a radio option. By rotating the rotatable wheel 2 clockwise or anticlockwise a user can select one of the two submenu options 32,34. In present embodiment, each of the submenu options 32,34 can be opened by pressing the activation button 31 and the digital camera 1 will enter a TV mode or a radio mode corresponding to a view 200 and a view 400.

In the view 200, a rotatable icon wheel 44 is displayed under a TV screen 42. The rotatable icon wheel 44 can be rotated by rotating the rotatable wheel 2 clockwise or anticlockwise and can select a channel for the TV. In the TV mode, the digital camera 1 can enter a TV channel setting mode corresponding to a view 300 by pressing the activation button 31. In the TV channel setting mode, the digital camera 1 can set a selected channel as a channel one or channel two etc.

In the view 400, a rotatable icon wheel 46 is displayed at the center of the screen 4. The rotatable icon wheel 46 can be rotated by rotating the rotatable wheel 2 clockwise or anticlockwise and can select a channel for the radio. In the radio mode, the digital camera 1 can enter a radio channel setting mode corresponding to a view 500 by pressing the activation button 31. In the radio channel setting mode, the digital camera 1 can set a selected channel as a channel one or channel two etc.

Referring to FIG. 2D, in a picture view mode of the digital camera 1, a number of icons 52 corresponding to a number of pictures are arranged in a curved fashion, for example, in a circle on the screen 4. Every icon 52 can be selected by rotating the rotatable wheel 2 clockwise or anticlockwise. When an icon 52 is selected, the picture corresponding to the icon 52 can be displayed on the screen 4. By pressing the activation button 31, the picture selected can be displayed in full screen mode.

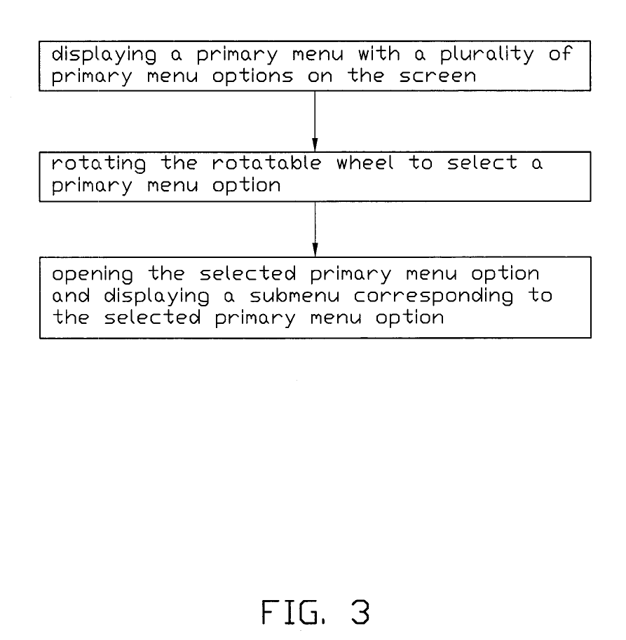

A menu display method of a digital camera 1 is also provided. Referring to FIG. 3, the method includes the steps of: displaying a primary menu 10 with a number of primary menu options 12 on the screen 4; rotating the rotatable wheel 2 to select a primary menu option 12; and opening the selected primary menu option 12 and displaying a submenu 20 corresponding to the selected primary menu option 12.

The submenu 20 is a disk-shaped and has a number of submenu options 22 selectable by rotating the rotatable wheel 2 displayed around the disk. The selected primary menu option 12 can be indicated differently from the others. For example, the selected primary menu option 12 can be indicated by brightening or darkening. In present embodiment, the number of buttons 3 includes an activation button 31, the activation button 31 is configured for opening the selected primary menu option 12, for example, by pressing it. Preferably, the activation button 31 is disposed in the center of the rotatable wheel 2.

The menu display system using in the digital camera has a disk-shaped submenu corresponding to a rotatable wheel of the digital camera, each submenu option of the submenu can be selected by rotating the rotatable wheel. The menu display system can be easily controlled by a simple input device, rotatable wheel, and can intuitively operate the digital camera. Accordingly, the digital camera having the menu display system can be operated quickly and efficiently.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A digital camera comprising:
a rotatable wheel;
a screen; and
a menu display system for displaying menu on the screen, the menu display system comprising:
a primary menu having a plurality of primary menu options; and
at least one submenu corresponding to the primary menu options, the submenu being disk-shaped with a plurality of submenu options displayed around the disk, each of the submenu options being selectable by rotating the rotatable wheel clockwise or anticlockwise.

2. The digital camera as claimed in claim 1, wherein the digital camera further comprises an activation button configured for opening a selected primary menu option or a selected submenu option, the activation button being disposed in the center of the rotatable wheel.

3. The digital camera as claimed in claim 1, wherein the plurality of primary menu options are arranged in a curved fashion on the screen.

4. The digital camera as claimed in claim 1, wherein the plurality of primary menu options are arranged in a circle on the screen.

5. The digital camera as claimed in claim 1, wherein the disk-shaped submenu is divided into many identically sized areas according to the plurality of the submenu options.

6. The digital camera as claimed in claim 1, wherein when a primary menu option or a submenu option is selected, the selected primary menu option or the selected submenu option is indicated differently from the others.

7. The digital camera as claimed in claim 6, wherein the selected primary menu option and the selected submenu option are indicated by brightening or darkening.

8. The digital camera as claimed in claim 1, wherein in a digital media mode of the digital camera, the rotatable wheel is used for controlling the channel of a TV or a radio.

9. A menu display method of a digital camera, the digital camera comprising a rotatable wheel, and a screen, comprising the steps of:
displaying a primary menu with a plurality of primary menu options on the screen;
rotating the rotatable wheel to select a primary menu option; and
opening the selected primary menu option and displaying a submenu corresponding to the selected primary menu option, the submenu being disk-shaped and having a plurality of submenu options selectable by rotating the rotatable wheel displayed around the disk.

10. The menu display method as claimed in claim 9, wherein the digital camera further comprises an activation button configured for opening a selected primary menu option or a selected submenu option, the activation button is disposed in the center of the rotatable wheel.

11. The menu display method as claimed in claim 9, wherein the plurality of primary menu options are arranged in a curved fashion on the screen.

12. The menu display method as claimed in claim 9, wherein the plurality of primary menu options are arranged in a circle on the screen.

13. The menu display method as claimed in claim 9, wherein the disk-shaped submenu is divided into many identically sized areas according to the plurality of the submenu options.

14. The menu display method as claimed in claim 9, wherein when a primary menu option or a submenu option is selected, the selected primary menu option or the selected submenu option is indicated differently from the others.

15. The menu display method as claimed in claim 14, wherein the selected primary menu option and the selected submenu option are indicated by brightening or darkening.
